(19) United States
(12) Patent Application Publication
(10) Pub. No.: US 2026/0217989 A1
(43) Pub. Date: Jul. 30, 2026

(54) LAMINATE AND RESIN-COATED METAL FOIL

(71) Applicant: Panasonic Intellectual Property Management Co., Ltd., Osaka (JP)

(72) Inventors: Yasunari TOMITA, Osaka (JP); Akihiro YAMAUCHI, Osaka (JP); Nobuo SHIBATA, Toyama (JP)

(73) Assignee: Panasonic Intellectual Property Management Co., Ltd., Osaka (JP)

(21) Appl. No.: 19/144,256

(22) PCT Filed: Dec. 20, 2023
(86) PCT No.: PCT/JP2023/045743

§ 371 Date: Jun. 27, 2025

(30) Foreign Application Priority Data
Dec. 27, 2022 (JP) 2022-210792

(51) Int. Cl. C09D 5/18; C09D 7/40; C09D 7/61; C09D 7/65; C09D 163/00; C09K 5/14

(52) U.S. Cl. CPC C09D 5/18; C09D 7/61; C09D 7/65; C09D 7/67; C09D 7/68; C09D 7/69; C09D 163/00; C09K 5/14

(57) ABSTRACT

A laminate includes: a metal layer; a first insulating layer; and a second insulating layer including a cured material of a resin composition. A proportion of a thickness of the first insulating layer to a thickness of the second insulating layer is lower than 10%. The resin composition contains an epoxy resin, a curing agent, a fluidity controlling agent, and a thermally conductive filler. A content of the thermally conductive filler based on a total mass of the resin composition is greater than or equal to 84% by mass and less than or equal to 97% by mass. The thermally conductive filler has at least two peaks within a range of a particle size larger than or equal to 0.05 μm and smaller than or equal to 25 μm in a volumetric particle size distribution measured by a laser scattering/diffraction method. The first insulating layer includes no inorganic filler.

### TECHNICAL FIELD

The present disclosure relates generally to laminates and resin-coated metal foil and more specifically relates to: a laminate including a metal layer and an insulating layer; and resin-coated metal foil including metal foil and a resin layer.

### BACKGROUND ART

Patent Literature 1 discloses an epoxy resin composition for thermal conductive materials. The epoxy resin composition for thermal conductive materials contains: an epoxy resin; a curing agent or a curing accelerator; and an inorganic filler (a thermally conductive filler). The epoxy resin has the feature that it contains a triphenylene skeleton.

The more a resin composition is filled with a thermally conductive filler, the better the thermal conductivity of an insulating layer formed from the resin composition can be, but the lower the insulation reliability of the insulating layer thus formed may be. The inventors attribute this to the following causes. The first cause is that ionic impurities migrate across a surface of the thermally conductive filler. The second cause is that voids remain in the insulating layer, between insulating layers, and between the insulating layer and a conductive layer. Patent Literature 1 seems to attempt to secure thermal conductivity and insulation properties by the thermally conductive filler itself (paragraph [0051]).

These two causes, however, cannot be solved by the thermally conductive filler itself.

### CITATION LIST

### Patent Literature

Patent Literature 1: JP 2017-008153 A

### SUMMARY OF INVENTION

It is an object of the present disclosure to provide a laminate and resin-coated metal foil from which an insulating layer having high thermal conductivity and high insulation reliability are formable.

A laminate according to an aspect of the present disclosure includes: a metal layer; a first insulating layer laid on the metal layer; and a second insulating layer laid on the first insulating layer and including a cured material of a resin composition. The proportion of a thickness of the first insulating layer to a thickness of the second insulating layer is lower than 10%. The resin composition contains an epoxy resin (A), a curing agent (B), a fluidity controlling agent (C), and a thermally conductive filler (D) having a thermal conductivity of higher than or equal to 10 W/m·K. The fluidity controlling agent (C) includes at least one of a polyether ester-type fluidity controlling agent (C1) including no phosphorus atom or a polyether ester phosphate-type fluidity controlling agent (C2). A content of the thermally conductive filler (D) based on a total mass of the resin composition is greater than or equal to 84% by mass and less than or equal to 97% by mass. The thermally conductive filler (D) has at least two peaks within a range of a particle size larger than or equal to 0.05 μm and smaller than or equal to 25 μm in a volumetric particle size distribution measured by a laser scattering/diffraction method. The first insulating layer includes no inorganic filler or includes an inorganic filler in a content lower than a content of the thermally conductive filler (D) in the second insulating layer.

Resin-coated metal foil according to an aspect of the present disclosure includes: metal foil; a first resin layer laid on the metal foil; and a second resin layer laid on the first resin layer and including a resin composition or a semi-cured product of the resin composition. A proportion of a thickness of the first resin layer to a thickness of the second resin layer is lower than 10%. The resin composition contains an epoxy resin (A), a curing agent (B), a fluidity controlling agent (C), and a thermally conductive filler (D) having a thermal conductivity of higher than or equal to 10 W/m·K. The fluidity controlling agent (C) includes at least one of a polyether ester-type fluidity controlling agent (C1) including no phosphorus atom or a polyether ester phosphate-type fluidity controlling agent (C2). A content of the thermally conductive filler (D) based on a total mass of the resin composition is greater than or equal to 84% by mass and less than or equal to 97% by mass. The thermally conductive filler (D) has at least two peaks within a range of a particle size larger than or equal to 0.05 μm and smaller than or equal to 25 μm in a volumetric particle size distribution measured by a laser scattering/diffraction method. The first resin layer is thermoplastic or has cured. The first resin layer includes no inorganic filler or includes an inorganic filler in a content lower than a content of the thermally conductive filler (D) in the second resin layer.

### BRIEF DESCRIPTION OF DRAWINGS

FIG. 1 is a schematic sectional view of a laminate according to an embodiment of the present disclosure;

FIG. 2 is a schematic sectional view of resin-coated metal foil according to an embodiment of the present disclosure;

FIG. 3 is a schematic sectional view of a test laminate; and

FIG. 4 is a schematic plan view of a test pattern.

### DESCRIPTION OF EMBODIMENTS

### 1. Overview

As described above, the more a resin composition is filled with a thermally conductive filler, the better the thermal conductivity of an insulating layer formed from the resin composition can be, but the lower the insulation reliability of the insulating layer thus formed may be.

The first cause of the reduction in insulation reliability is that ionic impurities migrate across a surface of the thermally conductive filler. Therefore, a means for restricting the migration of the ionic impurities is required.

Meanwhile, the second cause of the reduction in insulation reliability is that voids remain in the insulating layer, between insulating layers, and between the insulating layer and a conductive layer. For example, when a build-up process is executed to increase the number of layers of a printed circuit board, voids may remain if an insulating layer is not formed without a gap between two adjacent conductors. When the resin composition is highly filled with the thermally conductive filler to secure the thermal conductivity, voids are more likely to remain. In contrast, when the viscosity is reduced to secure the flowability of the resin composition, the insulating layer is more likely to have an uneven thickness. When a single insulating layer has an uneven thickness, the unevenness in thickness may be accumulated in the case of execution of the build-up process, which also has the risk that voids remain.

Therefore, the inventors intensively studied in view of the two causes of the reduction in the insulation reliability, and as a result, has developed a laminate 1 including an insulating layer having high insulation reliability with high thermal conductivity.

That is, the laminate 1 according to the present embodiment includes: a metal layer 2; a first insulating layer 31 laid on the metal layer 2; and a second insulating layer 32 laid on the first insulating layer 31 and including a cured material of a resin composition.

The proportion of a thickness T1 of the first insulating layer 31 to a thickness T2 of the second insulating layer 32 is lower than 10% (T1/T2<0.1).

The resin composition contains an epoxy resin (A), a curing agent (B), a fluidity controlling agent (C), and a thermally conductive filler (D) having a thermal conductivity of higher than or equal to 10 W/m·K.

The fluidity controlling agent (C) includes at least one of a polyether ester-type fluidity controlling agent (C1) including no phosphorus atom or a polyether ester phosphate-type fluidity controlling agent (C2).

The content of the thermally conductive filler (D) based on the total mass of the resin composition is greater than or equal to 84% by mass and less than or equal to 97% by mass. Even when the thermally conductive filler (D) is highly filled as in this case, the fluidity controlling agent (C) can impart appropriate flowability to the resin composition during molding. This presumably suppresses voids from remaining and increases the insulation reliability of an insulating layer 3 (in particular, the second insulating layer 32).

The thermally conductive filler (D) has at least two peaks within a range of a particle size larger than or equal to 0.05 μm and smaller than or equal to 25 μm in a volumetric particle size distribution measured by a laser scattering/diffraction method.

The first insulating layer 31 includes no inorganic filler or includes an inorganic filler in a content lower than the content of the thermally conductive filler (D) in the second insulating layer 32.

The first insulating layer 31 is present between the metal layer 2 and the second insulating layer 32, and thereby, ionic impurities are suppressed from migrating between the metal layer 2 and the second insulating layer 32. This enhances the insulation reliability of the insulating layer 3 (the first insulating layer 31 and the second insulating layer 32).

Moreover, the content of the thermally conductive filler (D) in the second insulating layer 32 is higher than the content of the thermally conductive filler (D) in the first insulating layer 31. Further, the thickness T2 of the second insulating layer 32 is more than 10 times the thickness T1 of the first insulating layer 31.

Thus, the present embodiment enables the insulating layer 3 having high thermal conductivity and high insulation reliability to be formed.

### 2. Details

The laminate 1 and resin-coated metal foil 10 according to the present embodiment will be described with reference to the drawings. Note that the drawings are schematic representations, and thus, the sizes, thicknesses, and other attributes of the respective constituent elements illustrated on those drawings are not always to scale, compared with actual ones. Arrows indicating respective directions in the drawings are not to define the directions of the laminate 1 and the resin-coated metal foil 10 in use but are merely shown to facilitate understanding of the description and are intangible. Note that the X-, Y-, and Z-axes are orthogonal to one another. In the following description, a view along the Z-axis is referred to as an XY plan view.

### (1) Laminate

First of all, the laminate 1 according to the present embodiment will be described. The laminate 1 is used, for example, for manufacturing a printed circuit board.

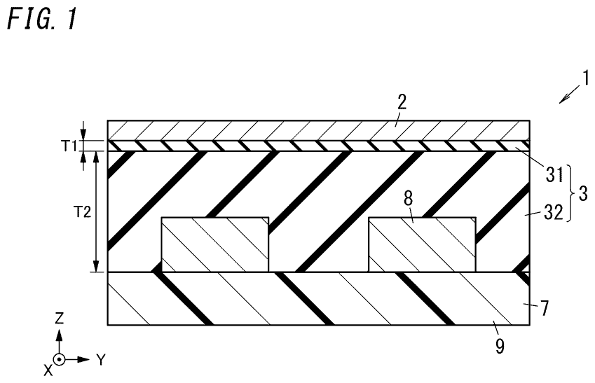

As shown in FIG. 1, the laminate 1 is in the shape of a plate having a thickness in the Z-axis direction and extending in the X-axis direction and the Y-axis direction. The laminate 1 includes the metal layer 2, the first insulating layer 31, and the second insulating layer 32. The first insulating layer 31 and the second insulating layer 32 may collectively be referred to as the “insulating layer 3”. The laminate 1 may further include a core material 7.

### <Metal Layer>

The metal layer 2 may be formed of metal foil or may be formed by plating or vapor deposition. Examples of metal from which the metal layer 2 is formed include, but are not particularly limited to, copper, stainless steel, nickel, and nichrome. An example of the thickness of the metal layer 2 is, but is not particularly limited to, being greater than or equal to 5 μm and less than or equal to 35 μm. Note that an unnecessary portion(s) of the metal layer 2 may be removed by, for example, etching as necessary.

### <First Insulating Layer>

The first insulating layer 31 is laid on the metal layer 2. Specifically, the first insulating layer 31 is laid on, and bonded to, one surface (surface in a negative direction of the Z-axis) of the metal layer 2.

The first insulating layer 31 is a layer formed from a resin composition having an electrically insulating property. The resin composition is not limited to a particular resin composition. The resin composition may be a resin composition containing a thermoplastic resin or may be a resin composition containing a thermosetting resin.

Examples of the resin composition containing the thermoplastic resin include, but are not particularly limited to, a resin composition containing a polyamideimide resin.

Examples of the resin composition containing the thermosetting resin include, but are not particularly limited to, a resin composition containing at least one of an epoxy resin, a curing agent (e.g., a phenol resin), a catalyst, a flame retardant, or a flexible component. The epoxy resin, the curing agent, the catalyst, and the flame retardant are each common with an epoxy resin (A), a curing agent (B), a catalyst, and a flame retardant, which will be described later, of the second insulating layer 32. Examples of the flexible component include, but are not particularly limited to, an epoxy denatured acrylic resin.

Note that the first insulating layer 31 contains no inorganic filler, or the first insulating layer 31 includes an inorganic filler in a content lower than the content of the thermally conductive filler (D) in the second insulating layer 32. Note that in the present specification, the “inorganic filler” means an inorganic filler in the broad sense including the thermally conductive filler (D). That is, the thermal conductivity of the thermally conductive filler (D) is higher than or equal to 10 W/m·K, but a thermally non-conductive filler having a thermal conductivity lower than 10 W/m·K is included in the “inorganic filler”.

The proportion of the thickness T1 of the first insulating layer 31 to the thickness T2 of the second insulating layer 32 is lower than 10% (T1/T2<0.1). This increases the thermal conductivity of the insulating layer 3. This particularly increases the thermal conductivity in a thickness direction defined with respect to the insulating layer 3.

### <Second Insulating Layer>

The second insulating layer 32 is laid on the first insulating layer 31. Specifically, the second insulating layer 32 is laid on, and bonded to, one surface (surface in the negative direction of the Z-axis) of the first insulating layer 31.

The second insulating layer 32 is an electrically insulating layer. The second insulating layer 32 includes the cured material of the resin composition. The resin composition contains an epoxy resin (A), a curing agent (B), a fluidity controlling agent (C), and a thermally conductive filler (D) having a thermal conductivity of higher than or equal to 10 W/m·K. The resin composition may further contain other components. Examples of the other components include, but are not particularly limited to, a catalyst, a flame retardant, a coupling agent, a dispersant, an inorganic filler, a metal deactivator, and an ion scavenger. Each component will be described sequentially below.

### <<Epoxy Resin (A)>>

The epoxy resin (A) has the property of curing by heating. Thus, the epoxy resin (A) can impart a thermosetting property to the resin composition. The epoxy resin (A) is a compound including at least one epoxy group per molecule. The epoxy resin (A) preferably includes two or more epoxy groups per molecule.

Examples of the epoxy resin (A) include, but are not particularly limited to, a trisphenol methane epoxy resin, a naphthalene epoxy resin, a biphenyl aralkyl epoxy resin, a biphenyl epoxy resin, and a dicyclopentadiene epoxy resin.

The trisphenol methane epoxy resin is particularly preferable. The trisphenol methane epoxy resin has three epoxy groups, each having a phenyl methane skeleton, per molecule. Thus, the trisphenol methane epoxy resin has a high functional group (epoxy group) density and can thus increase the glass transition temperature (Tg) of the cured material of the resin composition.

### <<Curing Agent (B)>>

The curing agent (B) includes at least one of a phenol resin or dicyandiamide.

The phenol resin is a prepolymer that can react with the epoxy resin (A). The phenol resin is a condensation reaction product of phenols and aldehydes.

Examples of the phenol resin include, but are not particularly limited to, a biphenyl aralkyl phenol resin, a phenyl aralkyl phenol resin, a novolac phenol resin, a cresol novolac phenol resin, a bisphenol A novolac phenol resin, a naphthalene phenol resin, a tetrakisphenol phenol resin, and a phosphorus denatured phenol resin.

The biphenyl aralkyl phenol resin is particularly preferable. The biphenyl aralkyl phenol resin can impart flame-retardant, heat resistant, and adhesive properties to the cured material of the resin composition.

The content of the curing agent (B), the ratio of the epoxy resin (A) and the curing agent (B) is preferably within the range from greater than or equal to 0.3 to less than or equal to 1.3, more preferably from greater than or equal to 0.4 to less than or equal to 1.0 in an equivalent ratio of phenol resin (B)/epoxy resin (A). The equivalent ratio is greater than or equal to 0.3, and therefore, the glass transition temperature (Tg) is less likely to lower, and thus, insufficient curing is less likely caused. Meanwhile, the equivalent ratio is less than or equal to 1.3, and therefore, a polar group, such as a hydroxy group, is suppressed from increasing, and thus, a smear can be suppressed from being formed when, for example, a hole is formed in the insulating layer 3.

### <<Fluidity Controlling Agent (C)>>

The fluidity controlling agent (C) is a component that can adjust the flowability of the resin composition during molding. The fluidity controlling agent (C) includes at least one of a polyether ester-type fluidity controlling agent (C1) including no phosphorus atom or a polyether ester phosphate-type fluidity controlling agent (C2).

Here, the polyether ester-type fluidity controlling agent (C1) including no phosphorus atom is effective in particular in a resin system combining the epoxy resin (A) and a phenol resin. That is, in such a resin system, even when the thermally conductive filler (D) is highly filled, the polyether ester-type fluidity controlling agent (C1) including no phosphorus atom can impart appropriate flowability to the resin composition during the molding.

Meanwhile, the polyether ester phosphate-type fluidity controlling agent (C2) is effective particularly in a resin system combining the epoxy resin (A) and dicyandiamide. That is, in such a resin system, even when the thermally conductive filler (D) is highly filled, the polyether ester phosphate-type fluidity controlling agent (C2) can impart appropriate flowability to the resin composition during the molding.

The fluidity controlling agent (C) is in liquid form at 25° C. and is non-ionic. This can make the thickness T2 of the second insulating layer 32 uniform. The thickness T2 of the second insulating layer 32 is more than 10 times the thickness T1 of the first insulating layer 31, which facilitates making the thickness (T1+T2) of the insulating layer 3 uniform as well.

The polyether ester-type fluidity controlling agent (C1) including no phosphorus atom has a plurality of ether structures, a plurality of ester structures, and a plurality of carboxy groups per molecule. The polyether ester-type fluidity controlling agent (C1) including no phosphorus atom as described above is obtained by, for example, causing a polyol having two to six hydroxyl groups to react with a phosphoric acid group-introducing or carboxy group-introducing substance at the ratio that the molar ratio of the hydroxyl groups to the phosphoric acid group-introducing or carboxy group-introducing substance is 3:1 to 1:1. The polyether ester-type fluidity controlling agent (C1) including no phosphorus atom and obtained in this way can suppress the resin composition from excessively increasing or decreasing in viscosity during the molding. This can make the thickness T2 of the second insulating layer 32 more uniform. Thus, making the thickness (T1+T2) of the insulating layer 3 more uniform is facilitated as well.

The content of the fluidity controlling agent (C) based on 100 parts by mass of the thermally conductive filler (D) is greater than or equal to 0.005 parts by mass and less than or equal to 0.5 parts by mass, more preferably greater than or equal to 0.008 parts by mass and less than or equal to 0.4 parts by mass, much more preferably greater than or equal to 0.01 parts by mass and less than or equal to 0.3 parts by mass. The content of the fluidity controlling agent (C) is greater than or equal to 0.005 parts by mass, and therefore, the effect by the fluidity controlling agent (C) can be exhibited. Note that the effect by the fluidity controlling agent (C) can be saturated when the content of the fluidity controlling agent (C) is greater than 0.5 parts by mass. This can make the thickness T2 of the second insulating layer 32 more uniform. Thus, making the thickness (T1+T2) of the insulating layer 3 more uniform is facilitated as well.

### <<Thermally Conductive Filler (D)>>

The thermally conductive filler (D) is an aggregate of thermally conductive particles. The thermal conductivity of the thermally conductive filler (D) is higher than or equal to 10 W/m·K. The higher the thermal conductivity of the thermally conductive filler (D), the better the thermal conductivity, which is preferable, but a practical upper limit is lower than or equal to 300 W/m·K. The thermally conductive filler (D) preferably includes at least one filler selected from the group consisting of a magnesium oxide filler, an aluminum nitride filler, and an aluminum oxide filler. This enables the second insulating layer 32 to have increased thermal conductivity as compared with the case where those fillers are not included. The thickness T2 of the second insulating layer 32 is more than 10 times the thickness T1 of the first insulating layer 31, and therefore, the insulating layer 3 easily has increased thermal conductivity as well.

The content of the thermally conductive filler (D) based on the total mass of the resin composition is greater than or equal to 84% by mass and less than or equal to 97% by mass, preferably greater than or equal to 85% by mass and less than or equal to 96% by mass, more preferably greater than or equal to 87% by mass and less than or equal to 94% by mass. The content of the thermally conductive filler (D) is greater than or equal to 84% by mass, which enables the second insulating layer 32 to have increased thermal conductivity. Thus, the insulating layer 3 easily has increased thermal conductivity as well. Meanwhile, the content of the thermally conductive filler (D) is less than or equal to 97% by mass, and therefore, the resin composition can be suppressed from decreasing in flowability or excessively increasing in viscosity during the molding.

The thermally conductive filler (D) has at least two peaks within a range of a particle size larger than or equal to 0.05 μm and smaller than or equal to 25 μm in a volumetric particle size distribution (frequency distribution) measured by a laser scattering/diffraction method. This enables particles of the thermally conductive filler (D) to be more proximate to each other in the second insulating layer 32.

Here, the particle size distribution is measured by the laser scattering/diffraction method. The particle size distribution is shown as a frequency distribution or an integrated distribution (cumulative distribution). In the present specification, the “integrated distribution” means an integrated undersize distribution.

The frequency distribution is a distribution shown with the horizontal axis representing the particle size and the vertical axis representing the proportion (by volume) of particles having respective particle sizes to the total particle volume. The horizontal axis may be illustrated in a logarithmic display.

Meanwhile, the integrated distribution (cumulative undersize distribution) is a distribution shown with the horizontal axis representing the particle size and the vertical axis representing the proportion (by volume) of particles smaller than or equal to a certain size to the total particle volume. The horizontal axis may be illustrated in a logarithmic display.

Preferably, the thermally conductive filler (D) includes: a first thermally conductive filler (D1); and a second thermally conductive filler (D2) having an average particle diameter smaller than an average particle diameter of the first thermally conductive filler (D1). This enables particles of the first thermally conductive filler (D1) to be brought into thermal contact with each other via particles of the second thermally conductive filler (D2) in the second insulating layer 32. This enables the second insulating layer 32 to have further increased thermal conductivity. As a result, the insulating layer 3 easily has increased thermal conductivity as well. Note that in the present specification, the “average particle diameter” means 50% diameter (D50 (median diameter)) of the integrated distribution (cumulative undersize distribution).

The average particle diameter of the first thermally conductive filler (D1) is preferably larger than 1 μm and smaller than or equal to 25 μm, more preferably larger than or equal to 4 μm and smaller than or equal to 20 μm. Meanwhile, the average particle diameter of the second thermally conductive filler (D2) is preferably larger than or equal to 0.05 μm and smaller than or equal to 1 μm, more preferably larger than or equal to 0.1 μm and smaller than or equal to 0.4 μm. This further promotes a thermal contact between the particles of the first thermally conductive filler (D1) via the particles of the second thermally conductive filler (D2) in the second insulating layer 32. This enables the second insulating layer 32 to have further increased thermal conductivity. As a result, the insulating layer 3 easily has increased thermal conductivity as well.

Preferably, the thermally conductive filler (D) has at least one peak within a range of a particle size larger than 1 μm and smaller than or equal to 25 μm and at least one peak within a range of a particle size larger than or equal to 0.05 μm and smaller than or equal to 1 μm in the volumetric particle size distribution (frequency distribution) measured by the laser scattering/diffraction method. This enables particles of the thermally conductive filler (D) to be more proximate to each other in the second insulating layer 32. This enables the second insulating layer 32 to have further increased thermal conductivity. As a result, the insulating layer 3 easily has increased thermal conductivity as well.

### Others

Examples of the catalyst include, but are not particularly limited to, an imidazole compound such as 2-ethyl-4-methylimidazole. The resin composition contains a catalyst, and thereby, the curing reaction of the resin composition during the molding can be promoted.

Examples of the flame retardant include, but are not particularly limited to, a phosphorus-based flame retardant, a halogen-based flame retardant, and an inorganic flame retardant. The resin composition contains the flame retardant, and therefore, the insulating layer 3 can be made flame retardant. The phosphorus-based flame retardant is halogen free and is thus preferable.

Examples of the coupling agent include, but are not particularly limited to, a silane coupling agent such as 8-glycidoxy octyltrimethoxysilane. The resin composition contains the coupling agent, and therefore, adhesion between the first insulating layer 31 and the second insulating layer 32, and adhesion between the second insulating layer 32 and the conductive layer 8 (see FIG. 1) can be improved.

Examples of the dispersant include, but are not particularly limited to, a moistening dispersant. The resin composition contains the dispersant, and therefore, the thermally conductive filler (D) can homogeneously be dispersed in the second insulating layer 32.

Examples of the inorganic filler include, but are not particularly limited to, a molybdenum compound filler, a silica filler, an aluminum hydroxide filler, a magnesium hydroxide filler, a talc filler, a clay filler, and a mica filler.

Examples of the metal deactivator include, but are not particularly limited to, a hydrazide derivative, an oxalic acid derivative, and a salicylic acid derivative. The resin composition contains the metal deactivator, and therefore, the metal deactivator forms a complex with an active metal ion (e.g., copper ion) that promotes oxidation deterioration. This suppresses the second insulating layer 32 from deteriorating.

Examples of the ion scavenger include, but are not particularly limited to, hydrotalcite. The resin composition contains the ion scavenger, and therefore, the ion scavenger traps an ionic impurity. This suppresses ion migration. Thus, the insulation reliability of the second insulating layer 32 is ensured.

### <Core Material>

As described above, the laminate 1 does not have to include the core material 7. Examples of the core material 7 include, but are not particularly limited to, a printed circuit board. The core material 7 is in the shape of a plate having a thickness in the Z-axis direction and extending in the X-axis direction and the Y-axis direction. The core material 7 includes an insulating substrate 9 and a conductive layer 8.

### <<Insulating Substrate>>

The insulating substrate 9 is an electrically insulating substrate. The insulating substrate 9 is in the shape of a plate having a thickness in the Z-axis direction and extending in the X-axis direction and the Y-axis direction. The insulating substrate 9 is laid on the second insulating layer 32. Specifically, the insulating substrate 9 is laid on, and is bonded to, one surface (surface in the negative direction of the Z-axis) of the second insulating layer 32.

### <<Conductive Layer>>

The conductive layer 8 includes at least one of a signal layer for transmitting an electrical signal, a power supply layer for supplying power, or a ground layer for achieving a ground potential.

The conductive layer 8 is bonded to the insulating substrate 9. Specifically, in the present embodiment, the conductive layer 8 is bonded to one surface (surface in the positive direction of the Z-axis) of the insulating substrate 9. The conductive layer 8 may be bonded to the other surface (surface in the negative direction of the Z-axis) of the insulating substrate 9.

In the present embodiment, the conductive layer 8 is buried in the second insulating layer 32. Note that the conductive layer 8 is not in contact with the first insulating layer 31. Thus, the thickness of the conductive layer 8 is smaller than the thickness T2 of the second insulating layer 32. The thickness of the conductive layer 8 is, but is not particularly limited to being, for example, greater than or equal to 12 μm and less than or equal to 210 μm.

### Operation and Advantages

In the present embodiment, the first insulating layer 31 includes no inorganic filler or includes an inorganic filler in a content lower than the content of the thermally conductive filler (D) in the second insulating layer 32. This suppresses the ionic impurity from migrating within the first insulating layer 31.

Even when the ionic impurity is present in the second insulating layer 32, the first insulating layer 31 is present between the metal layer 2 and the second insulating layer 32, and thereby, ionic impurities are suppressed from migrating between the metal layer 2 and the second insulating layer 32. This enhances the insulation reliability of the insulating layer 3 (the first insulating layer 31 and the second insulating layer 32). For example, in FIG. 1, short circuiting between the metal layer 2 and the conductive layer 8 is suppressed.

Meanwhile, the content of the thermally conductive filler (D) in the second insulating layer 32 is higher than the content of the thermally conductive filler (D) in the first insulating layer 31. Further, the thickness T2 of the second insulating layer 32 is more than 10 times the thickness T1 of the first insulating layer 31. Thus, the insulating layer 3 (the first insulating layer 31 and the second insulating layer 32) has increased thermal conductivity.

Thus, the present embodiment enables the insulating layer 3 having high thermal conductivity and high insulation reliability to be formed.

### (2) Resin-Coated Metal Foil

The resin-coated metal foil 10 according to the present embodiment will now be described. The resin-coated metal foil 10 is used, for example, for manufacturing a printed circuit board. Specifically, the resin-coated metal foil 10 is used when a build-up process is executed to increase the number of layers of the printed circuit board.

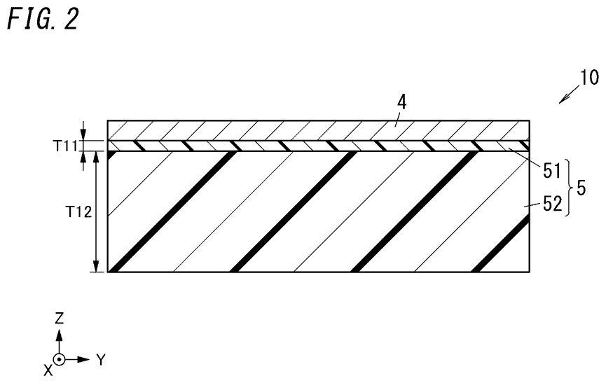

As shown in FIG. 2, the resin-coated metal foil 10 is in the shape of a sheet having a thickness in the Z-axis direction and extending in the X-axis direction and the Y-axis direction. The resin-coated metal foil 10 includes metal foil 4, a first resin layer 51, and a second resin layer 52. The metal foil 4, the first resin layer 51, and the second resin layer 52 respectively correspond to the metal layer 2, the first insulating layer 31, and the second insulating layer 32 in the laminate 1 described above. The first resin layer 51 and the second resin layer 52 may collectively be referred to as a “resin layer 5”. The resin layer 5 molded is the insulating layer 3. The resin-coated metal foil 10 is usable as, for example, a build-up material.

### <Metal Foil>

The metal foil 4 corresponds to the metal layer 2 in the laminate 1 described above. Examples of the metal foil 4 include, but are not particularly limited to, copper foil (electrolytic copper foil and roll copper foil), stainless steel foil, nickel foil, and Nichrome foil. The thickness of the metal foil 4 is, but is not particularly limited to being, for example, greater than or equal to 5 μm and less than or equal to 35 μm.

### <First Resin Layer>

The first resin layer 51 corresponds to the first insulating layer 31 in the laminate 1 described above. The first resin layer 51 is laid on the metal foil 4. Specifically, the first resin layer 51 is laid on, and is bonded to, one surface (surface in the negative direction of the Z-axis) of the metal foil 4.

The first resin layer 51 is thermoplastic or has cured. This enables the first resin layer 51 to suppress the second resin layer 52 from coming into contact the metal foil 4 during the molding.

The first resin layer 51 includes no inorganic filler, or the first resin layer 51 includes an inorganic filler in a content lower than the content of the thermally conductive filler (D) in the second resin layer 52.

The proportion of a thickness T11 of the first resin layer 51 to a thickness T12 of the second resin layer 52 is lower than 10% (T11/T12<0.1). This facilitates that after the resin layer 5 is molded, the proportion of the thickness T1 of the first insulating layer 31 to the thickness T2 of the second insulating layer 32 is lower than 10% (T1/T2<0.1).

### <Second Resin Layer>

The second resin layer 52 corresponds to the second insulating layer 32 in the laminate 1 described above. The second resin layer 52 molded is the second insulating layer 32.

The second resin layer 52 is laid on the first resin layer 51. Specifically, the second resin layer 52 is laid on, and is bonded to, one surface (surface in the negative direction of the Z-axis) of the first resin layer 51.

The second resin layer 52 includes a resin composition or a semi-cured product of the resin composition. The resin composition included in the second resin layer 52 is common with the resin composition included in the second insulating layer 32 described above, and therefore, the description of the resin composition included in the second resin layer 52 is omitted.

### Operation and Advantages

The resin-coated metal foil 10 according to the present embodiment can be used as a build-up material, thereby easily manufacturing the laminate 1. For example, the resin-coated metal foil 10 is laid on the core material 7 and is heated and pressurized, thereby manufacturing the laminate 1. The insulating layer 3 in the laminate 1 thus obtained has high thermal conductivity and high insulation reliability.

### 3. Aspects

As can be seen from the embodiment described above, the present disclosure includes aspects described below. In the following description, reference signs in parentheses are added only to explicitly show the correspondence relationship to the embodiment.

A first aspect is a laminate (1) including: a metal layer (2); a first insulating layer (31) laid on the metal layer (2); and a second insulating layer (32) laid on the first insulating layer (31) and including a cured material of a resin composition. A proportion of a thickness (T1) of the first insulating layer (31) to a thickness (T2) of the second insulating layer (32) is lower than 10%. The resin composition contains an epoxy resin (A), a curing agent (B), a fluidity controlling agent (C), and a thermally conductive filler (D) having a thermal conductivity of higher than or equal to 10 W/m·K. The fluidity controlling agent (C) includes at least one of a polyether ester-type fluidity controlling agent (C1) including no phosphorus atom or a polyether ester phosphate-type fluidity controlling agent (C2). A content of the thermally conductive filler (D) based on a total mass of the resin composition is greater than or equal to 84% by mass and less than or equal to 97% by mass. The thermally conductive filler (D) has at least two peaks within a range of a particle size larger than or equal to 0.05 μm and smaller than or equal to 25 μm in a volumetric particle size distribution measured by a laser scattering/diffraction method. The first insulating layer (31) includes no inorganic filler or includes an inorganic filler in a content lower than a content of the thermally conductive filler (D) in the second insulating layer (32).

This aspect enables an insulating layer (3) having high thermal conductivity and high insulation reliability to be formed.

A second aspect is a laminate (1) based on the first aspect. In the second aspect, the thermally conductive filler (D) includes at least one filler selected from the group consisting of a magnesium oxide filler, an aluminum nitride filler, and an aluminum oxide filler.

This aspect enables the thermal conductivity of the insulating layer (3) to be further increased.

A third aspect is a laminate (1) based on the first or second aspect. In the third aspect, the thermally conductive filler (D) includes a first thermally conductive filler (D1) and a second thermally conductive filler (D2) having an average particle diameter smaller than an average particle diameter of the first thermally conductive filler (D1).

This aspect enables the thermal conductivity of the insulating layer (3) to be further increased.

A fourth aspect is a laminate (1) based on the third aspect. In the fourth aspect, the average particle diameter of the first thermally conductive filler (D1) is larger than 1 μm and smaller than or equal to 25 μm. The average particle diameter of the second thermally conductive filler (D2) is larger than or equal to 0.05 μm and smaller than or equal to 1 μm.

This aspect enables the thermal conductivity of the insulating layer (3) to be further increased.

A fifth aspect is a laminate (1) based on any one of the first to fourth aspects. In the fifth aspect, the thermally conductive filler (D) has at least one peak within a range of a particle size larger than 1 μm and smaller than or equal to 25 μm and at least one peak within a range of a particle size larger than or equal to 0.05 μm and smaller than or equal to 1 μm in a volumetric particle size distribution measured by a laser scattering/diffraction method.

This aspect enables the thermal conductivity of the insulating layer (3) to be further increased.

A sixth aspect is a laminate (1) based on any one of the first to fifth aspects. In the sixth aspect, the fluidity controlling agent (C) is in liquid form at 25° C. and is non-ionic.

This aspect enables the insulating layer (3) to have a uniform thickness.

A seventh aspect is a laminate (1) based on any one of the first to sixth aspects. In the seventh aspect, the polyether ester-type fluidity controlling agent (C1) including no phosphorus atom has a plurality of ether structures, a plurality of ester structures, and a plurality of carboxy groups per molecule.

This aspect enables the insulating layer (3) to have a more uniform thickness.

An eighth aspect is a laminate (1) based on any one of the first to seventh aspects. In the eighth aspect, a content of the fluidity controlling agent (C) based on 100 parts by mass of the thermally conductive filler (D) is greater than or equal to 0.005 parts by mass and less than or equal to 0.5 parts by mass.

This aspect enables the insulating layer (3) to have a more uniform thickness.

A ninth aspect is a laminate (1) based on any one of the first to eighth aspects. In the ninth aspect, the curing agent (B) includes at least one of a phenol resin or dicyandiamide.

This aspect enables the insulating layer (3) to have further enhanced insulation reliability.

A tenth aspect is resin-coated metal foil (10) including: metal foil (4); a first resin layer (51) laid on the metal foil (4); and a second resin layer (52) laid on the first resin layer (51) and including a resin composition or a semi-cured product of the resin composition. A proportion of a thickness (T11) of the first resin layer (51) to a thickness (T12) of the second resin layer (52) is lower than 10%. The resin composition contains an epoxy resin (A), a curing agent (B), a fluidity controlling agent (C), and a thermally conductive filler (D) having a thermal conductivity of higher than or equal to 10 W/m·K. The fluidity controlling agent (C) includes at least one of a polyether ester-type fluidity controlling agent (C1) including no phosphorus atom or a polyether ester phosphate-type fluidity controlling agent (C2). A content of the thermally conductive filler (D) based on a total mass of the resin composition is greater than or equal to 84% by mass and less than or equal to 97% by mass. The thermally conductive filler (D) has at least two peaks within a range of a particle size larger than or equal to 0.05 μm and smaller than or equal to 25 μm in a volumetric particle size distribution measured by a laser scattering/diffraction method. The first resin layer is thermoplastic or has cured. The first resin layer (51) includes no inorganic filler or includes an inorganic filler in a content lower than a content of the thermally conductive filler (D) in the second resin layer (52).

This aspect enables an insulating layer (3) having high thermal conductivity and high insulation reliability to be formed.

An eleventh aspect is resin-coated metal foil (10) based on the tenth aspect. In the eleventh aspect, the thermally conductive filler (D) includes at least one filler selected from the group consisting of a magnesium oxide filler, an aluminum nitride filler, and an aluminum oxide filler.

This aspect enables the thermal conductivity of the insulating layer (3) to be further increased.

A twelfth aspect is resin-coated metal foil (10) based on the tenth or eleventh aspect. In the twelfth aspect, the thermally conductive filler (D) includes a first thermally conductive filler (D1) and a second thermally conductive filler (D2) having an average particle diameter smaller than an average particle diameter of the first thermally conductive filler (D1).

This aspect enables the thermal conductivity of the insulating layer (3) to be further increased.

A thirteenth aspect is resin-coated metal foil (10) referring to the twelfth aspect. In the thirteenth aspect, the average particle diameter of the first thermally conductive filler (D1) is larger than 1 μm and smaller than or equal to 25 μm. The average particle diameter of the second thermally conductive filler (D2) is larger than or equal to 0.05 μm and smaller than or equal to 1 μm.

This aspect enables the thermal conductivity of the insulating layer (3) to be further increased.

A fourteenth aspect is resin-coated metal foil (10) referring to any one of the tenth to thirteenth aspects. In a fourteenth aspect, the thermally conductive filler (D) has at least one peak within a range of a particle size larger than 1 μm and smaller than or equal to 25 μm and at least one peak within a range of a particle size larger than or equal to 0.05 μm and smaller than or equal to 1 μm in a volumetric particle size distribution measured by a laser scattering/diffraction method.

This aspect enables the thermal conductivity of the insulating layer (3) to be further increased.

A fifteenth aspect is resin-coated metal foil (10) referring to any one of the tenth to fourteenth aspects. In the fifteenth aspect, the fluidity controlling agent (C) is in liquid form at 25° C. and is non-ionic.

This aspect enables the insulating layer (3) to have a uniform thickness.

A sixteenth aspect is resin-coated metal foil (10) referring to any one of the tenth to fifteenth aspects. In the sixteenth aspect, the polyether ester-type fluidity controlling agent (C1) including no phosphorus atom has a plurality of ether structures, a plurality of ester structures, and a plurality of carboxy groups per molecule.

This aspect enables the insulating layer (3) to have a more uniform thickness.

A seventeenth aspect is resin-coated metal foil (10) referring to any one of the tenth to sixteenth aspects. In the seventeenth aspect, a content of the fluidity controlling agent (C) based on 100 parts by mass of the thermally conductive filler (D) is greater than or equal to 0.005 parts by mass and less than or equal to 0.5 parts by mass.

This aspect enables the insulating layer (3) to have a more uniform thickness.

An eighteenth aspect is resin-coated metal foil (10) referring to any one of the tenth to seventeenth aspects. In the eighteenth aspect, the curing agent (B) includes at least one of a phenol resin or dicyandiamide.

This aspect enables the insulating layer (3) to have further enhanced insulation reliability.

### EXAMPLES

The present disclosure will specifically be described with reference to examples below. Note that the present disclosure is not limited to the examples.

### 1. Examples and Comparative Examples

### (1) Raw Materials

Raw materials used for a resin composition of each of the examples and comparative examples are as follows.

### <Epoxy Resin (A)>

Epoxy resin 1: a trisphenol methane epoxy resin, epoxy equivalent of 158 to 178 g/eq, manufactured by Nippon Kayaku Co., Ltd. under the product name “EPPN502H”
Epoxy resin 2: a trisphenol methane epoxy resin, epoxy equivalent of 150 to 180 g/eq, manufactured by DIC Corporation under the product name “HP-7250”

Note that the epoxy resin in the first insulating layer and the epoxy resin (A) in the second insulating layer are the same.

### <Curing Agent (B)>

Curing agent 1: a biphenyl aralkyl phenol resin, hydroxyl group equivalent of 132 g/eq, manufactured by UBE Corporation under the product name “MEHC-7403H”
Curing agent 2: dicyandiamide (Dicy)

Note that the phenol resin in the first insulating layer and the curing agent 1 in the second insulating layer are the same.

### <Fluidity Controlling Agent (C)>

### <<Polyether Ester-Type Fluidity Controlling Agent (C1) Including No Phosphorus Atom>>

Polyether ester-type: manufactured by Kusumoto Chemicals, Ltd. under the product name “DISPARLON 3350EF”

### <<Polyether Ester Phosphate-Type Fluidity Controlling Agent (C2)>>

Polyether ester phosphate-type: manufactured by Kusumoto Chemicals, Ltd. under the product name “DISPARLON 3500”

### <Thermally Conductive Filler (D)>

### <<First Thermally Conductive Filler (D1)>>

Aluminum oxide filler 1: manufactured by NIPPON STEEL Chemical & Material Co., Ltd. under the product name “AZ10-20”
Aluminum nitride filler: manufactured by Tokuyama Corporation under the product name “HF-10c”

### <<Second Thermally Conductive Filler (D2)>>

Aluminum oxide filler 2: manufactured by Admatechs Company Limited under the product name “AO-502” (specific surface area 6.5 to 9.0 m²/g)

### Others

### <<Catalyst>>

2-ethyl-4-methylimidazole manufactured by Shikoku Chemicals Corporation under the product name “2E4MZ”

### <<Flame Retardant>>

A phosphazene-based flame retardant (non-halogen flame retardant) manufactured by FUSHIMI Pharmaceutical Co., Ltd. under the product name “FP-100”

### <<Flexible Component>>

An epoxy denatured acrylic resin manufactured by Nagase ChemteX Corporation under the product name “PASR-001”

### <<Coupling Agent>>

A silane coupling agent (8-glycidoxy octyltrimethoxysilane) manufactured by Shin-Etsu Chemical Co., Ltd. under the product name “KBM-4803”

### <<Dispersant>>

A moistening dispersant manufactured by BYK-Chemie under the product name “BYK-W903”

### <<Inorganic Filler>>

A molybdenum compound filler manufactured by J. M. Huber Corporation under the product name “KG-501”

### <<Metal Deactivator>

Hydrazide-based: manufactured by ADEKA CORPORATION under the product name “CDA-10”

### <<Ion Scavenger>>

Hydrotalcite-based: inorganic ion scavenger manufactured by TOAGOSEI CO., LTD. under the product name “IXEPLAS-A1”

### (2) Resin Composition

For each of the examples and the comparative examples, a resin composition for the first insulating layer and a resin composition for the second insulating layer were manufactured in the following manner.

### (2.1) Resin Composition for First Insulating Layer

### (2.1.1) Examples 1 to 4 and Comparative Example 5

A resin composition for the first insulating layer of each of Examples 1 to 4 is a resin composition containing an epoxy resin. At amounts (unit: parts by mass) shown in Table 1 and Table 2, an epoxy resin, a phenol resin, a catalyst, a flame retardant, and a flexible component were dissolved in methyl ethyl ketone, thereby obtaining a solution of the resin composition for the first insulating layer of each of Examples 1 to 4 and Comparative Example 5.

### (2.1.2) Examples 5 to 8

A resin composition for the first insulating layer of each of Examples 5 to 8 is a resin composition containing a polyamideimide resin. A mixture having a polymer concentration of 15% by mass was obtained by mixing 192 g of (50 mol %) trimellitic acid anhydride (Nacalai Tesque, Inc.), 211 g of (40 mol %) 4,4′-diisocyanate-3,3′-dimethyl biphenyl, 35 g of (10 mol %) 2,4-diisocyanatotoluene, 1 g of diazabicycloundecene (manufactured by San-Apro Ltd.), and 2482 g of N,N-dimethyl acetamide (DMAC, Nacalai Tesque, Inc.) together. The mixture was heated to 100° C. in 1 hour, and subsequently, the mixture was kept at 100° C. for 6 hours to promote reaction.

Then, 1460 g of DMAC were further added to the mixture to adjust the polymer concentration to 10% by mass, and subsequently, the mixture was cooled to a room temperature. Thus, a solution of the resin composition for the first insulating layer of each of Examples 5 to 8 was obtained.

### (2.2) Resin Composition for Second Insulating Layer

Raw materials at amounts (unit: parts by mass) shown in Table 1 and Table 2 were mixed together, thereby obtaining a mixture. The mixture was dissolved or dispersed in a mixed solvent of methyl ethyl ketone and dimethyl formamide, and the mixed solvent was then stirred in a revolution mixer, thereby preparing a solution of a resin composition of each of the examples and the comparative examples. The ratio of methyl ethyl ketone:dimethyl formamide (volume ratio) in the mixed solvent=0 to 100:100 to 0.

TABLE 1
(Unit parts by mass)

| | | | | Example | | | | | | | |
|---|---|---|---|---|---|---|---|---|---|---|---|
| | | | | 1 | 2 | 3 | 4 | 5 | 6 | 7 | 8 |
| First | Epoxy Resin | | Epoxy Resin 1 | 20.0 | 20.0 | 20.0 | 20.0 | 0 | 0 | 0 | 0 |
| Insulating | | | Epoxy Resin 2 | 40.0 | 40.0 | 40.0 | 40.0 | 0 | 0 | 0 | 0 |
| Layer | Phenolic Resin | | Curing Agent 1 | 40.0 | 40.0 | 40 0 | 40.0 | 0 | 0 | 0 | 0 |
| | Catalyst | | | 0.5 | 0.5 | 0.5 | 0.5 | 0 | 0 | 0 | 0 |
| | Flame Retardant | | | 10.0 | 10.0 | 10.0 | 10.0 | 0 | 0 | 0 | 0 |
| | Flexible Component | | | 50.0 | 50.0 | 50.0 | 50.0 | 0 | 0 | 0 | 0 |
| | Polyamideamide Resin | | | 0 | 0 | 0 | 0 | 100.0 | 100.0 | 100.0 | 100.0 |
| Second | Epoxy Resin (A) | | Epoxy Resin 1 | 20.0 | 20.0 | 20.0 | 30.0 | 20.0 | 20 0 | 20.0 | 30.0 |
| Insulating | | | Epoxy Resin 2 | 40.0 | 40.0 | 40.0 | 65.0 | 40.0 | 40.0 | 40.0 | 65.0 |
| Layer | Curing Agent (B | | Curing Agent 1 | 40.0 | 40.0 | 40.0 | 0 | 40.0 | 40.0 | 40.0 | 0 |
| | | | Curing Agent 2 | 0 | 0 | 0 | 5.0 | 0 | 0 | 0 | 5.0 |
| | Catalyst | | | 0.5 | 0.5 | 0.5 | 0.5 | 0.5 | 0.5 | 0.5 | 0.5 |
| | Flame Retardant | | | 10.0 | 10.0 | 10.0 | 10.0 | 10.0 | 10.0 | 10.0 | 10.0 |
| | Coupling Agent | | | 17.8 | 16.1 | 10.8 | 18.3 | 17.8 | 16.1 | 10.8 | 18.3 |
| | Dispersant | | | 12.5 | 11.3 | 7.5 | 12.0 | 12.5 | 11.3 | 7.5 | 12.8 |
| | Thermally | First Thermally | Aluminum Oxide Filler 1 | 1026.0 | 0 | 0 | 1055.0 | 1028.0 | 0 | 0 | 1055.0 |
| | Conductive | Conductive Filler (D1) | Aluminum Nitride Filler | 0 | 975.0 | 850.0 | 0 | 0 | 975.0 | 650.0 | 0 |
| | Filter (D) | Second Thermally | Aluminum Oxide Filler 2 | 685.3 | 566.0 | 377.3 | 703.3 | 685.3 | 566.0 | 377.3 | 703.3 |
| | | Conductive Filler (D2) | | | | | | | | | |

| | | | | | | | | | |
|---|---|---|---|---|---|---|---|---|---|
| Inorganic Filler | Molybdenum Compound Filer | 70.0 | 70.0 | 50.0 | 72.0 | 70.0 | 70.0 | 50.0 | 72.0 |
| Metal Deactivator | Hydrazide-Based | 1.0 | 1.0 | 1.0 | 1.0 | 1.0 | 1.0 | 1.0 | 1.0 |
| Ion Scavenger | Hydrotalcite-Based | 20.0 | 18.0 | 12.0 | 20.0 | 20.0 | 18.0 | 12.0 | 20.0 |
| Fluidity Controlling | Polyether Ester-Type (C1) | 1.2 | 1.2 | 1.2 | 0 | 1.2 | 1.2 | 1.2 | 0 |
| Agent (C) | Polyether Ester | 0 | 0 | 0 | 1.2 | 0 | 0 | 0 | 1.2 |
| | Phosphate-Type (C2) | | | | | | | | |

TABLE 2
(Unit parts by mass)

| | | | | Comparative Example | | | | | |
|---|---|---|---|---|---|---|---|---|---|
| | | | | 1 | 2 | 3 | 4 | 5 | 6 |
| First | Epoxy Resin | | Epoxy Resin 1 | 0 | 0 | 0 | 0 | 20.0 | 0 |
| Insulating | | | Epoxy Resin 2 | 0 | 0 | 0 | 0 | 40.0 | 0 |
| Layer | Phenolic Resin | | Curing Agent 1 | 0 | 0 | 0 | 0 | 40.0 | 0 |
| | Catalyst | | | 0 | 0 | 0 | 0 | 0.5 | 0 |
| | Flame Retardant | | | 0 | 0 | 0 | 0 | 10.0 | 0 |
| | Flexible Component | | | 0 | 0 | 0 | 0 | 50.0 | 0 |
| | Polyamideimide Resin | | | 0 | 0 | 0 | 0 | | 0 |
| Second | Epoxy Resin (A) | | Epoxy Resin 1 | 20.0 | 20.0 | 20.0 | 30.0 | 20.0 | 20.0 |
| Insulating | | | Epoxy Resin 2 | 40.0 | 40.0 | 40.0 | 65.0 | 40.0 | 40.0 |
| Layer | Curing Agent (B) | | Curing Agent 1 | 40.0 | 40.0 | 40.0 | 0 | 40.0 | 40.0 |
| | | | Curing Agent 2 | 0 | 0 | 0 | 5.0 | 0 | 0 |
| | Catalyst | | | 0.5 | 0.5 | 0.5 | 0.5 | 0.5 | 0.5 |
| | Flame Retardant | | | 10.0 | 10.0 | 10.0 | 10.0 | 10.0 | 10.0 |
| | Coupling Agent | | | 17 8 | 16.1 | 10.8 | 18.3 | 17.8 | 10.1 |
| | Dispersant | | | 12.5 | 11.3 | 7.5 | 12.8 | 12.5 | 7.1 |
| | Thermally | First Thermally | Aluminum Oxide Filler 1 | 1028.0 | 0 | 0: | 1055.0 | 1028.0 | 1025.0 |
| | Conductive | Conductive Filler (D1) | Aluminum Nitride Filler | 0 | 975.0 | 650.0 | 0 | 0 | 0 |
| | Filler (D) | Second Thermally | Aluminum Oxide Filler 2 | 685.3 | 566.0 | 377.3 | 703.3 | 685.3 | 0 |
| | | Conductive Filler (D2) | | | | | | | |

| | | | | | | | |
|---|---|---|---|---|---|---|---|
| Inorganic Filler | Molybdenum Compound Filler | 70.0 | 70.0 | 50.0 | 72.0 | 70.0 | 11.0 |
| Metal Deactivator | Hydrazide-Based | 1.0 | 10 | 1.0 | 1.0 | 1.0 | 1.0 |
| Ion Scavenger | Hydrotalcite-Based | 20.0 | 18.0 | 12.0 | 20.0 | 20.0 | 12.0 |
| Fluidity Controling Agent (C) | Polyether Ester-Type (C1) | 12 | 1.2 | 1.2 | 0 | 1.2 | 1.2 |
| | Polyether Ester | 0 | 0 | 0 | 1.2 | 0 | 0 |
| | Phosphate-Type (C2) | | | | | | |

Table 3 shows D50 (50% diameter of integrated distribution) and D99 (99% diameter of integrated distribution) of the thermally conductive filler (D).

TABLE 3
(Unit: μm)

| | | D50 | D99 |
|---|---|---|---|
| First Thermally Conductive | Aluminum Oxide Filler 1 | 8-10 | <40 |
| Filler (D1) | Aluminum Nitride Filler | 5-10 | <40 |
| Second Thermally Conductive | Aluminum Oxide Filler 2 | 0.2-0.3 | <5 |
| Filler (D2) | | | |

### (3) Resin-Coated Metal Foil

As the metal foil 4 was used surface-treated electrolytic copper foil (manufactured by Furukawa Electric Co., Ltd. under the product name “F2-WS”, nominal thickness: 18 μm, size: 550 mm×700 mm).

For Examples 1 to 4 and Comparative Example 5, the resin composition for the first insulating layer was applied to one surface of the metal foil 4 and was dried at 200° C. for 3 to 5 minutes, thereby forming the first resin layer 51 having a thickness of 5 to 20 μm.

Meanwhile, for Examples 5 to 8, the resin composition for the first insulating layer was applied to one surface of the metal foil 4 and was heated at 200° C. for 4 minutes, and was subsequently heated at 250° C. for 10 minutes, thereby forming the first resin layer 51 having a thickness of 5 μm.

Then, the resin composition for the second insulating layer was applied to the first resin layer 51 and was dried at 150° C. for 2 to 5 minutes, thereby forming the second resin layer 52 having a thickness 50 to 200 μm. Thus, resin-coated metal foil (size: 510 mm×340 mm) as shown in FIG. 2 was obtained.

Note that for Comparative Examples 1 to 4 and 6, no first resin layer 51 was formed, but the second resin layer 52 was directly formed on the metal foil 4. Note that the proportion of the thickness T11 of the first resin layer 51 to the thickness T12 of the second resin layer 52 was substantially equal to the proportion of the thickness T1 of the first insulating layer 31 to the thickness T2 of the second insulating layer 32.

### (4) Test Laminate

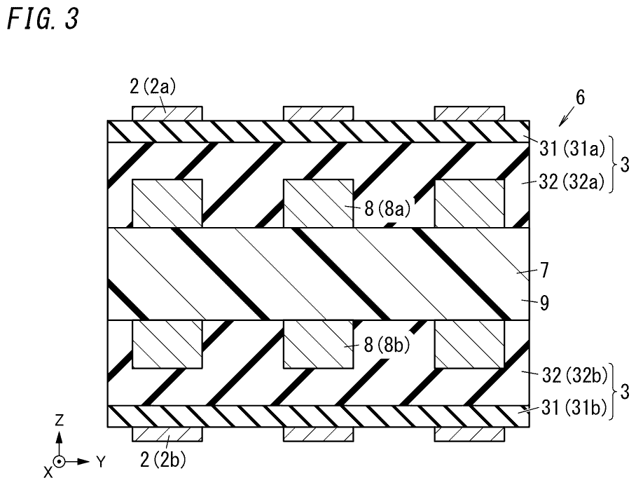

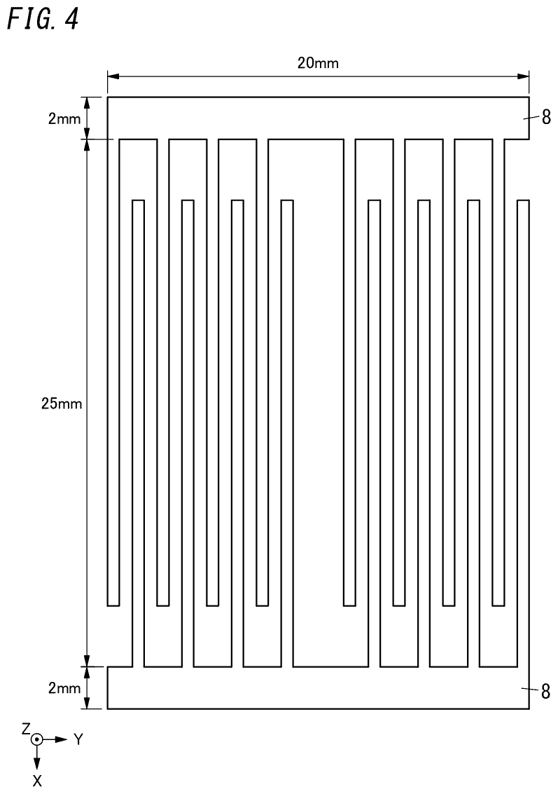

A test laminate 6 as shown in FIG. 3 was manufactured as follows. As the core material 7 was used a double-sided copper-clad laminate (manufactured by Panasonic Corporation under the product name “R-1566S”, a high heat resistant halogen free multilayer substrate material, thickness: 400 μm, thickness of each copper foil: 105 μm, size: 515 mm×340 mm). Copper foil on each of both surfaces of the double-sided copper-clad laminate was etched, thereby forming the conductive layer 8 having a test pattern (comb-shaped pattern) shown and FIG. 4 in XY plan view.

Then, the resin layer 5 of the resin-coated metal foil 10 described above was laid on each of both surfaces of a core material 13 and was heated and pressurized at 200° C. and 3 MPa for 60 minutes, thereby manufacturing the test laminate 6 (see FIG. 3). Thereafter, an unnecessary part(s) of the copper foil on each of both the surfaces of the test laminate 6 was removed by etching, thereby forming the metal layer 2 having a comb-shaped pattern similar to the conductive layer 8 in the XY plan view.

### 2. Evaluation

### (1) Thermal Conductivity

The resin layer 5 of the resin-coated metal foil 10 was cured by heating, thereby obtaining the insulating layer 3. The thermal conductivity of the insulating layer 3 was measured by a laser-flash method defined by JIS R 1611. The results are shown in Table 4 and Table 5.

### (2) Insulation Reliability

The test laminate 6 described above was placed in an environment of 85° C./85% rh, and the resistance value of the insulating layer 3 (the first insulating layer 31 and the second insulating layer 32) was measured while a voltage of 900 V was applied between an external layer (a metal layer 2a shown in FIG. 3 has a comb-shaped pattern shown in FIG. 4 in XY plan view) and an internal layer (a conductive layer 8a shown in FIG. 3 has a comb-shaped pattern shown in FIG. 4 in XY plan view). A time period after the application of the voltage was started until the resistance value dropped to or below 1×10⁷Ω (whether or not the time period exceeds 150 hours) was monitored. The results are shown in Table 4 and Table 5.

TABLE 4

| | | | Example | | | | | | | |
|---|---|---|---|---|---|---|---|---|---|---|
| | | Unit | 1 | 2 | 3 | 4 | 5 | 8 | 7 | 8 |
| Ion Scavenger | Content | mass % | 1.0 | 1.0 | 1.0 | 1.0 | 1.0 | 1.0 | 1.0 | 1.0 |
| Heavy Metal Deactivator | Content | phr | 1.0 | 1.0 | 1.0 | 1.0 | 1.0 | 1.0 | 1.0 | 1.0 |
| Thermally Conductive | (D1)/(D2) | — | 60/40 | 67/33 | 67/33 | 60/40 | 60/40 | 67/33 | 67/33 | 60/40 |
| | Volume Ratio | | | | | | | | | |
| Filler (D) | Content | mass % | 88 | 87 | 84 | 88 | 88 | 87 | 84 | 88 |
| Particle Size Distribution | First Thermally | μm | 0.17 | 0.17 | 0.17 | 0.17 | 0.17 | 0.17 | 0.17 | 0.17 |
| Peak Position | Conductive | | | | | | | | | |
| | Filler (D1) | | | | | | | | | |
| | Second | μm | 9.30 | 9.50 | 9.50 | 9.30 | 9.30 | 9.50 | 9.50 | 9.30 |
| | Thermally | | | | | | | | | |
| | Conductive | | | | | | | | | |
| | Filler (D2) | | | | | | | | | |
| Thermal Conductivity | — | W/m · K | 3.8 | 5.2 | 3.7 | 3.8 | 3.8 | 5.2 | 3.7 | 3.8 |
| of Insulating Layer | | | | | | | | | | |
| Insulation Reliability (Average) | — | Hours | 1500< | 1500< | 1500< | 1500< | 1500< | 1500< | 1500< | 1500< |
| Thickness T1 of First | — | μm | 5 | 5 | 5 | 5 | 5 | 5 | 5 | 5 |
| Insulating Layer | | | | | | | | | | |
| Thickness T2 of Second | — | μm | 100 | 100 | 100 | 100 | 100 | 100 | 100 | 100 |
| Insulating Layer | | | | | | | | | | |
| T1/T2 | — | — | 0.05 | 0.05 | 0.05 | 0.05 | 0.05 | 0.05 | 0.05 | 0.05 |

TABLE 5

| | | | Comparative Example | | | | | |
|---|---|---|---|---|---|---|---|---|
| | | Unit | 1 | 2 | 3 | 4 | 5 | 6 |
| Ion Scavenger | Content | mass % | 1.0 | 1.0 | 1.0 | 1.0 | 1.0 | 1.0 |
| Heavy Metal Deactivator | Content | phr | 1.0 | 1.0 | 1.0 | 1.0 | 1.0 | 1.0 |
| Thermally Conductive | (D1)/(D2) | — | 60/40 | 67/33 | 67/33 | 60/40 | 60/40 | 100/0 |
| | Volume Ratio | | | | | | | |
| Filler (D) | Content | mass % | 88 | 87 | 84 | 88 | 88 | 87 |
| Particle Size Distribution | First Thermally | μm | 0.17 | 0.17 | 0.17 | 0.17 | 0.17 | — |
| | Conductive | | | | | | | |
| | Filler (D1) | | | | | | | |
| Peak Position | Second | μm | 9.30 | 9.50 | 9.50 | 9.30 | 9.30 | 9.30 |
| | Thermally | | | | | | | |
| | Conductive | | | | | | | |
| | Filler (D2) | | | | | | | |
| Thermal Conductivity of Insulating Layer | — | W/m · K | 4 | 5.5 | 3.9 | 4 | 3.3 | |
| Insulation Reliability (Average) | — | Hours | 1273 | 612 | 897 | 258 | 1500< | Film |
| Thickness T1 of First Insulating Layer | — | μm | — | — | — | — | 20 | Forming |
| Thickness T2 of Second Insulating Layer | — | μm | 100 | 100 | 100 | 100 | 100 | Impossible |
| T1/T2 | — | — | — | — | — | — | 0.2 | |

### REFERENCE SIGNS LIST

1 Laminate
2 Metal Layer
3 Insulating Layer
31 First Insulating Layer
32 Second Insulating Layer
10 Resin-Coated Metal Foil
4 Metal Foil
51 First Resin Layer
52 Second Resin Layer

1. A laminate comprising:
a metal layer;
a first insulating layer laid on the metal layer; and
a second insulating layer laid on the first insulating layer and including a cured material of a resin composition,
a proportion of a thickness of the first insulating layer to a thickness of the second insulating layer being lower than 10%,
the resin composition containing an epoxy resin (A), a curing agent (B), a fluidity controlling agent (C), and a thermally conductive filler (D) having a thermal conductivity of higher than or equal to 10 W/m·K,
the fluidity controlling agent (C) includes at least one of a polyether ester-type fluidity controlling agent (C1) including no phosphorus atom or a polyether ester phosphate-type fluidity controlling agent (C2),
a content of the thermally conductive filler (D) based on a total mass of the resin composition being greater than or equal to 84% by mass and less than or equal to 97% by mass,
the thermally conductive filler (D) having at least two peaks within a range of a particle size larger than or equal to 0.05 μm and smaller than or equal to 25 μm in a volumetric particle size distribution measured by a laser scattering/diffraction method,
the first insulating layer including no inorganic filler or including an inorganic filler in a content lower than a content of the thermally conductive filler (D) in the second insulating layer.

2. The laminate of claim 1, wherein
the thermally conductive filler (D) includes at least one filler selected from the group consisting of a magnesium oxide filler, an aluminum nitride filler, and an aluminum oxide filler.

3. The laminate of claim 1, wherein
the thermally conductive filler (D) includes a first thermally conductive filler (D1) and a second thermally conductive filler (D2) having an average particle diameter smaller than an average particle diameter of the first thermally conductive filler (D1).

4. The laminate of claim 3, wherein
the average particle diameter of the first thermally conductive filler (D1) is larger than 1 μm and smaller than or equal to 25 μm, and
the average particle diameter of the second thermally conductive filler (D2) is larger than or equal to 0.05 μm and smaller than or equal to 1 μm.

5. The laminate of claim 1, wherein
the thermally conductive filler (D) has at least one peak within a range of a particle size larger than 1 μm and smaller than or equal to 25 μm and at least one peak within a range of a particle size larger than or equal to 0.05 μm and smaller than or equal to 1 μm in a volumetric particle size distribution measured by a laser scattering/diffraction method.

6. The laminate of claim 1, wherein
the fluidity controlling agent (C) is in liquid form at 25° C. and is non-ionic.

7. The laminate of claim 1, wherein
the polyether ester-type fluidity controlling agent (C1) including no phosphorus atom has a plurality of ether structures, a plurality of ester structures, and a plurality of carboxy groups per molecule.

8. The laminate of claim 1, wherein
a content of the fluidity controlling agent (C) based on 100 parts by mass of the thermally conductive filler (D) is greater than or equal to 0.005 parts by mass and less than or equal to 0.5 parts by mass.

9. The laminate of claim 1, wherein
the curing agent (B) includes at least one of a phenol resin or dicyandiamide.

10. Resin-coated metal foil comprising:
metal foil;
a first resin layer laid on the metal foil; and
a second resin layer laid on the first resin layer and including a resin composition or a semi-cured product of the resin composition,
a proportion of a thickness of the first resin layer to a thickness of the second resin layer being lower than 10%,
the resin composition containing an epoxy resin (A), a curing agent (B), a fluidity controlling agent (C), and a thermally conductive filler (D) having a thermal conductivity of higher than or equal to 10 W/m·K,
the fluidity controlling agent (C) including at least one of a polyether ester-type fluidity controlling agent (C1) including no phosphorus atom or a polyether ester phosphate-type fluidity controlling agent (C2),
a content of the thermally conductive filler (D) based on a total mass of the resin composition being greater than or equal to 84% by mass and less than or equal to 97% by mass,
the thermally conductive filler (D) having at least two peaks within a range of a particle size larger than or equal to 0.05 μm and smaller than or equal to 25 μm in a volumetric particle size distribution measured by a laser scattering/diffraction method,
the first resin layer being thermoplastic or has cured,
the first resin layer including no inorganic filler or including an inorganic filler in a content lower than a content of the thermally conductive filler (D) in the second resin layer.

11. The resin-coated metal foil of claim 10, wherein
the thermally conductive filler (D) includes at least one filler selected from the group consisting of a magnesium oxide filler, an aluminum nitride filler, and an aluminum oxide filler.

12. The resin-coated metal foil of claim 10, wherein
the thermally conductive filler (D) includes a first thermally conductive filler (D1) and a second thermally conductive filler (D2) having an average particle diameter smaller than an average particle diameter of the first thermally conductive filler (D1).

13. The resin-coated metal foil of claim 12, wherein
the average particle diameter of the first thermally conductive filler (D1) is larger than 1 μm and smaller than or equal to 25 μm, and
the average particle diameter of the second thermally conductive filler (D2) is larger than or equal to 0.05 μm and smaller than or equal to 1 μm.

14. The resin-coated metal foil of claim 10, wherein
the thermally conductive filler (D) has at least one peak within a range of a particle size larger than 1 μm and smaller than or equal to 25 μm and at least one peak within a range of a particle size larger than or equal to 0.05 μm and smaller than or equal to 1 μm in a volumetric particle size distribution measured by a laser scattering/diffraction method.

15. The resin-coated metal foil of claim 10, wherein
the fluidity controlling agent (C) is in liquid form at 25° C. and is non-ionic.

16. The resin-coated metal foil of claim 10, wherein
the polyether ester-type fluidity controlling agent (C1) including no phosphorus atom has a plurality of ether structures, a plurality of ester structures, and a plurality of carboxy groups per molecule.

17. The resin-coated metal foil of claim 10, wherein
a content of the fluidity controlling agent (C) based on 100 parts by mass of the thermally conductive filler (D) is greater than or equal to 0.005 parts by mass and less than or equal to 0.5 parts by mass.

18. The resin-coated metal foil of claim 10, wherein
the curing agent (B) includes at least one of a phenol resin or dicyandiamide.
